(19) United States
(12) Patent Application Publication
(10) Pub. No.: US 2007/0121254 A1
(43) Pub. Date: May 31, 2007

(54) Protective and conductive layer for giant magnetoresistance

(75) Inventor: Perry A. Holman, Garland, TX (US)

Correspondence Address: Kris T. Fredrick;Honeywell International Inc., Patent Department, 101 Columbia Road, Morristown, NJ, 07962, US

(73) Assignee: Honeywell International Inc.

(21) Appl. No.: 11/288,534

(22) Filed: Nov. 29, 2005

(51) Int. Cl. G11B 5/127; G11B 5/33

(52) U.S. Cl. 360/324.1

(57) ABSTRACT

Giant magnetoresistance structures exhibiting a giant magnetoresistive effect are provided, and apparatuses incorporating said structures. The structures incorporate a giant magnetoresistive element that is surrounded by protective layers that are capable of shielding the element from harsh environmental conditions, thereby enabling their use in harsh environments.

### BACKGROUND OF THE INVENTION

1. Field of the Invention

The invention relates to giant magnetoresistance structures. More particularly, the invention pertains to structures exhibiting a giant magnetoresistive effect and apparatuses incorporating said structures. The structures are resistant to harsh environmental conditions, and are particularly acceptable for use in automobiles and other vehicles.

2. Description of Related Art

Magnetoresistance is the property of some materials to lose or gain electrical resistance when an external magnetic field is applied to them. A “Giant Magnetoresistance (GMR) Element” is a term of art that is used for thin film structures that comprise alternating ferromagnetic and non-magnetic metal layers and that exhibit what is known as the Giant Magnetoresistance Effect. The Giant Magnetoresistance effect is a quantum mechanical effect observed in such thin film structures. The effect manifests itself as a significant increase in resistance when the magnetization of the subsequent ferromagnetic layers are opposite compared to a lower level of resistance when the magnetization of the layers are parallel. The spin of the electrons of the non-magnetic material align parallel or anti-parallel with an applied magnetic field in equal numbers, and therefore suffer less magnetic scattering when the magnetizations of the ferromagnetic layers are parallel.

The GMR effect is large compared to what is known as the Anisotropy Magnetoresistance (AMR), or the Anisotropic Magnetoresistance effect. The AMR effect refers to the fact that the resistance in the magnetized conductors parallel and perpendicular to the magnetization direction differs. The AMR effect is a matter of a volume effect that occurs only in single ferromagnetic layers, as opposed to film structures having alternating ferromagnetic and non-magnetic metal layers. While AMR resistors exhibit a change of resistance of <3%, GMR materials achieve a much greater change of about 10% to 20%.

In many applications of magnetic sensors, magnetoresistive elements such as nickel iron are used to detect the component of a magnetic field that lies in the plane of the magnetoresistive material. In order to monitor the changes in the resistance of the material, associated components such as amplifiers are generally connected together to form an electrical circuit which provides an output signal that is representative of the strength of the magnetic field in the plane of the sensing elements. When the circuit is provided on a silicon substrate, electrical connections between associated components can be made above the surface of the silicon or by appropriately doped regions beneath the components and within the body of the silicon substrate. Components can be connected to each other above the surface of the silicon by disposing conductive material to form electrically conductive paths between the components. When components are connected in electrical communication with each other by appropriately doped regions within the silicon substrate, an electrically conductive path can be formed by diffusing a region of the silicon with an appropriate impurity, such as phosphorous, arsenic or boron to form electrically conductive connections between the components. U.S. Pat. No. 5,667,879, which is incorporated herein by reference in its entirety, discloses an AMR structure disposed on a substrate in such a way that an electrical connection to the magnetoresistive material is made from both above and below the magnetoresistive element.

As GMR technology continues to evolve, GMR materials are becoming increasingly useful and significant for a broad spectrum of industries. For example, GMR materials are conventionally used for computer memory and hard-disk drive products, but emerging markets include non-volatile memory chips, magnetic field sensors, and ultra-high speed isolators. U.S. Pat. No. 6,426,620 teaches a magnetic field sensing element. U.S. Pat. No. 6,175,477 teaches a GMR spin valve sensor. U.S. Pat. No. 6,075,361 teaches a GMR device comprising a Wheatstone bridge. Giant magnetoresistance can be used for devices such as motion detectors, current transformers, and in various automotive sensor applications.

While GMR devices enjoy wide application, particularly in the computer industry, such devices are typically not capable of withstanding harsh conditions, such as in-engine automotive environments. Accordingly, utilizing existing GMR processes, known GMR devices have limited usefulness in automotive applications, and there is a need in the art for improved GMR devices that are capable of withstanding such automotive environmental requirements. The present invention provides a solution to this need.

The invention provides a structure comprising a GMR element that is surrounded by protecting layers which protect the GMR sensing layers of the GMR element from environmental concerns. For example, in a standard permalloy-containing AMR structure, such as described in U.S. Pat. No. 5,667,879 and illustrated in FIG. 2 (not drawn to scale), permalloy contains iron which easily rusts. Accordingly, a protective layer of tantalum nitride (TaN) is provided which protects the iron from rusting, even in harsh environments. The present invention presents a similar structure that is capable of protecting the critical layers of a complex giant magnetoresistance element, allowing the GMR effect to be exploited in virtually any harsh environment.

### SUMMARY OF THE INVENTION

The invention provides a structure comprising:
a) a substrate;
b) a first non-magnetically sensitive, electrically conductive, corrosion resistant layer on a surface of the substrate;
c) a multilayer giant magnetoresistance element on a surface of the first non-magnetically sensitive, electrically conductive, corrosion resistant layer, said giant magnetoresistance element comprising:
   i) a first magnetically sensitive layer;
   ii) a non-magnetically sensitive spacer layer on a surface said first magnetically sensitive layer; and
   iii) a second magnetically sensitive layer on a surface of said spacer layer; and
d) a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer.

The invention also provides an apparatus comprising:
a) a substrate;
b) a first non-magnetically sensitive, electrically conductive, corrosion resistant layer on a surface of the substrate;
c) a multilayer giant magnetoresistance element on a surface of the first non-magnetically sensitive, electrically conductive, corrosion resistant layer, said giant magnetoresistance element comprising:
   i) a first magnetically sensitive layer;
   ii) a non-magnetically sensitive spacer layer on a surface said first magnetically sensitive layer; and
   iii) a second magnetically sensitive layer on a surface of said spacer layer;
d) a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer; and
e) a circuit connected to said second non-magnetically sensitive, electrically conductive, corrosion resistant layer, said circuit being responsive to a change in a magnetic field detected by said giant magnetoresistance element.

The invention further provides a process for forming a structure which comprises:
a) providing a substrate;
b) forming a first non-magnetically sensitive, electrically conductive, corrosion resistant layer on a surface of the substrate;
c) forming a multilayer giant magnetoresistance element on a surface of the first non-magnetically sensitive, electrically conductive, corrosion resistant layer, said giant magnetoresistance element comprising:
   i) a first magnetically sensitive layer;
   ii) a non-magnetically sensitive spacer layer on a surface said first magnetically sensitive layer; and
   iii) a second magnetically sensitive layer on a surface of said spacer layer; and
d) forming a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer.

### BRIEF DESCRIPTION OF THE DRAWINGS

FIG. 1 illustrates a schematic representation of a GMR structure of the invention.

FIG. 2 illustrates a schematic representation of an AMR structure of the prior art.

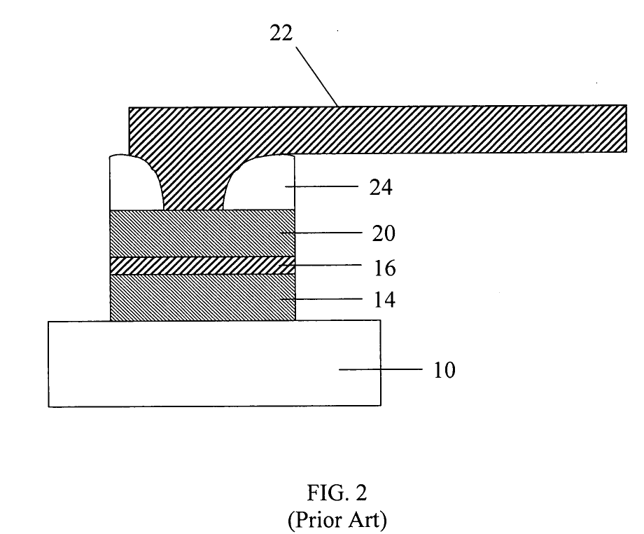

FIG. 3 is a schematic representation of an alternate GMR structure of the invention.

### DETAILED DESCRIPTION OF THE INVENTION

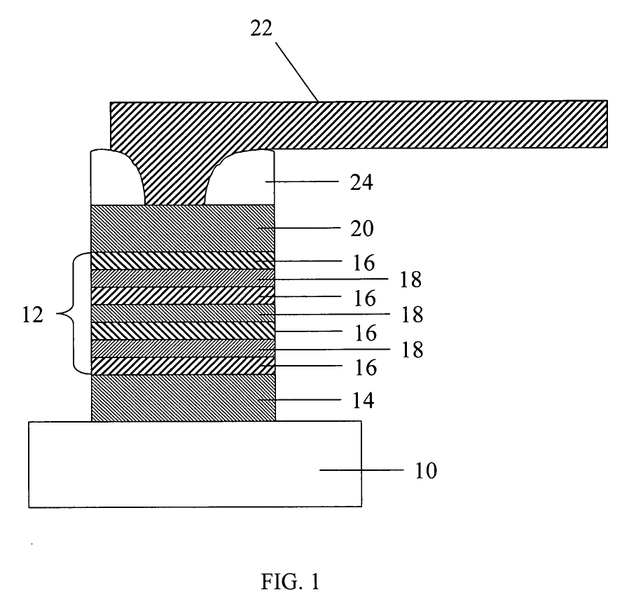

The structures of the invention are formed by depositing a multilayer magnetic field sensing element onto a suitable substrate. As illustrated in FIG. 1 (not drawn to scale), a first non-magnetically sensitive, electrically conductive, corrosion resistant layer 14 is positioned on a surface of a substrate 10. Reference numeral 12 represents a multilayer giant magnetoresistance element on a surface of the first non-magnetically sensitive, electrically conductive, corrosion resistant layer 14. At minimum, giant magnetoresistance element 12 comprises i) a first magnetically sensitive layer 16; ii) a non-magnetically sensitive spacer layer 18 on a surface said first magnetically sensitive layer 16; and iii) a second magnetically sensitive layer 16 on a surface of said spacer layer 18. Preferably, giant magnetoresistance element 12 includes at least one additional magnetically sensitive layer 16, provided that two adjacent magnetically sensitive layers 16 are separated by a spacer layer 18. Capping the giant magnetoresistance element 12 is a second non-magnetically sensitive, electrically conductive, corrosion resistant layer 20. Accordingly, the giant magnetoresistance element 12 is positioned between and in contact with each of said first non-magnetically sensitive, electrically conductive, corrosion resistant layer 14 and said second non-magnetically sensitive, electrically conductive, corrosion resistant layer 20.

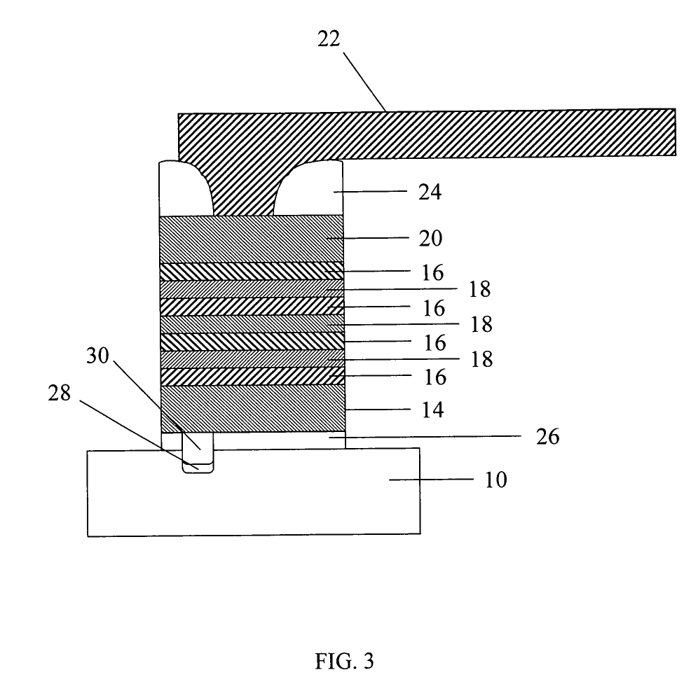

In the preferred embodiments of the invention, suitable substrates non-exclusively include silicon, silicon containing materials, glass, alumina, and integrated and non-integrated semiconductor materials. Of these, a silicon substrate is preferred. As illustrated in FIG. 3, a coating of silicon dioxide (SiO₂) or silicon nitride (SiN) may optionally be formed on the top surface of the substrate 10 to which the first non-magnetically sensitive, electrically conductive, corrosion resistant layer 14 is attached. This optional coating 26 is preferably about 1 μm thick and may be applied using techniques that are well known in the art. In another preferred embodiment, the substrate comprises a silicon substrate and further comprises a conductive diffusion 28 such as phosphorous, arsenic and/or boron disposed in a surface of the silicon substrate and diffused into it. A conductive diffusion is formed by doping a pre-selected region of the silicon substrate with an appropriate impurity, such as phosphorous, and/or boron, and then diffusing the impurity into the silicon. The conductive diffusion 28 is used to provide a conductive path between associated components formed on the surface of the substrate. Additionally, a conductive contact material 30 having a low specific contact resistance is preferably disposed on the conductive diffusion. In a preferred embodiment of the invention, the conductive contact material 30 is a silicide, such as platinum silicide. Preferably, both an optional conductive diffusion 28 and the conductive contact material 30 are formed within the body of the silicon. This is illustrated in FIG. 3, which is only a schematic representation and does not illustrate a completely patterned and etched structure. For example, a conductive diffusion is used to provide a conductive path between associated components formed on the surface of the substrate. Accordingly, the structure is preferably designed to achieve this conductive path, as described, for example, in U.S. Pat. No. 5,667,879. Preferably, the GMR structures of the invention are formed using substantially similar techniques to those described in U.S. Pat. No. 5,667,879 which describes the formation of AMR structures.

The first and second non-magnetically sensitive, electrically conductive, corrosion resistant layers 14 and 20 may each be independently formed from identical or different materials. Suitable non-magnetically sensitive, electrically conductive, corrosion resistant materials for the formation of said layers non-exclusively include refractory materials, particularly a refractory nitride or a refractory oxide material. Preferred refractory nitride materials include tantalum nitride and titanium nitride. Preferred refractory oxide materials include tantalum oxide and titanium oxide. Each of these materials is generally referred to in the art as a tantalum salt or titanium salt, respectively. Also preferred for the formation of layers 14 and 20 is titanium tungsten (TiW) and combinations of the above materials. Most preferably, both layer 14 and layer 20 each independently comprise tantalum nitride. Tantalum nitride is preferred because of its excellent properties, such as high sheet resistance which prevents electrical shunts that could otherwise occur if alternative materials are used.

As illustrated in FIG. 1, the giant magnetoresistance element 12 comprises alternating magnetically sensitive layers 16 and non-magnetically sensitive spacer layers 18. The giant magnetoresistance element 12 comprises at least two magnetically sensitive layers 16, and preferably comprises more than two magnetically sensitive layers 16. Each magnetically sensitive layer 16 is independently formed from a material such as permalloy, nickel, cobalt, iron, manganese, iridium or an alloy or a combination thereof. Suitable alloys non-exclusively include nickel-manganese alloys, cobalt-iron alloys, copper-iron alloys, nickel-iron alloys, nickel-iron-cobalt alloys, and combinations thereof. The term “permalloy” refers to an alloy of nickel and iron with about 20% iron content and about 80% nickel content. It has a high magnetic permeability and displays magnetoresistive characteristics. In the most preferred embodiment of the invention, the first and second magnetically sensitive layers 16 and any additional magnetically sensitive layer 16 each preferably comprise either permalloy or a nickel-iron alloy.

Suitable materials for the formation of spacer layers 18 non-exclusively include copper, cobalt oxide, rubidium, molybdenum, aluminum oxide, or a combination thereof. Each spacer layer 18 may independently comprise the same material or a different material. In the most preferred embodiment of the invention, each spacer layer comprises copper.

This structure is electrically connected to an appropriate device through an electrically conductive connector 22, which connector is preferably in direct electrical contact with either said first non-magnetically sensitive, electrically conductive, corrosion resistant layer or said first non-magnetically sensitive, electrically conductive, corrosion resistant layer, forming a circuit. Accordingly, connection to the giant magnetoresistive material can be easily be made from both above the giant magnetoresistive element and from below the giant magnetoresistive element. Alternately, an electrically conductive connector 22 may be attached to both of layers 14 and 20.

Electrically conductive connector 22 is formed by depositing a layer of an electrically conductive material, such as aluminum, onto at least one of the first protective non-magnetically sensitive, electrically conductive, corrosion resistant layer 14, or the second protective non-magnetically sensitive, electrically conductive, corrosion resistant layer 20. This layer of electrically conductive material is then preferably patterned and etched into a desired form, e.g. a serpentine pattern, using well known photolithographic techniques.

As illustrated in FIGS. 1 and 3, the structure further preferably includes a non-corrosive intermediate layer 24 which is disposed over layer 20. In the event that etchants applied to the GMR structures are corrosive to the underlying layers of the giant magnetoresistant element 12, intermediate layer 24 will protect the element during the etching process. For example, aluminum etchants typically contain phosphoric acid, whose effects are detrimental to materials such as permalloy because the acid will etch iron. Aluminum etchants can undercut the corrosion resistant layer 20 and attack or remove sensor elements. In this case, the use of such a intermediate layer 24 is preferred. In addition, an intermediate layer 24 may significantly improve the ability of the electrically conductive connector 22 to withstand electromigration. The intermediate layer 24 provides this advantageous characteristic by being an alternative electrical conductor in the regions where the aluminum may experience damage due to electromigration. Electromigration is caused by current density gradients. Electromigration results in mechanical damage of the conduction material which will eventually result in a loss of the conductive path. Intermediate layer 24 preferably comprises a non-corrosive material such as titanium tungsten, as is well known in the art. As seen in the figure, a portion of intermediate layer 24 must be removed or etched to bring electrically conductive connector 22 into electrical contact with layer 20.

Offering further protection to the GMR structure, a passivation layer of silicon nitride or silicon dioxide may be deposited over the entire structure in order to protect all of the components during any subsequent processing. This optional passivation layer (not illustrated) is preferably from about 0.5 μm to about 1.0 μm thick. Additional optional layers may be further included as may be determined by one skilled in the art. In general, each of the individual layers described herein may be patterned, etched and interconnected as is well known in the art and readily determined by one skilled in the art.

Each of the individual layers of the above described structure may deposited using techniques that are well known in-the art, such as spin coating the material on to surface, dip coating, spray coating, chemical vapor deposition (CVD), rolling the material onto a surface, dripping the material on to a surface, and/or spreading the material onto a surface. Also suitable for some materials are well known electrodeposition, electroplating, electroless plating and sputtering techniques, including ion beam and reactive sputtering. In a preferred embodiment, each of the electrically conducive layers are deposited by sputtering. Deposition conditions will vary with chemistry and desired deposition thickness.

In the preferred embodiments of the invention, the substrate 10 preferably has a thickness of from about 125 μm to about 625 μm, more preferably from about 250 μm to about 375 μm. Each of the first non-magnetically sensitive, electrically conductive, corrosion resistant layer 14 and the second non-magnetically sensitive, electrically conductive, corrosion resistant layer 20 preferably has a thickness of from about 300 Å to about 1200 Å, more preferably from about 500 Å to about 900 Å. Each of the first and second magnetically sensitive layers 16 and any additional magnetically sensitive layers preferably have a thickness of from about 30 Å to about 500 Å, more preferably from about 50 Å to about 200 Å. Each non-magnetically sensitive spacer layer 18 preferably has a thickness of from about 5 Å to about 500 Å, more preferably from about 50 Å to about 200 Å. The electrically conductive connector 22 preferably has a thickness of from about 100 Å to about 10,000 Å, more preferably from about 1000 Å to about 8000 Å. One angstrom (Å) is equivalent to 10₋₁₀ meters (0.1 nanometer).

Overall, the combined giant magnetoresistance element 12 preferably has a thickness of from about 0.5 μm to about 5 μm, more preferably from about 1 μm to about 2 μm, and preferably comprises from about 1 to about 10 magnetically sensitive layers, more preferably from about 2 to about 5 magnetically sensitive layers, and most preferably from about 2 to about 3 magnetically sensitive layers. While such thicknesses are preferred, it is to be understood that other layer thicknesses may be produced to satisfy a particular need and yet fall within the scope of the present invention.

The structures of the invention are preferably electrically connected to a device, forming an integrated or non-integrated circuit. The circuit is responsive to a change in a magnetic field detected by said giant magnetoresistance element. In the preferred embodiment of the invention, the structures of the invention are attached to a circuit which comprises a component of a vehicle. As discussed above, while the structures of the present invention are well suited for use under any type of environmental conditions, the structures of the invention are ideally suited for use in harsh environmental conditions, such as those associated with automobiles and other vehicles. For instance, the GMR structures of the invention may be used to monitor the anti-lock braking performance of a vehicle. For example, in the wheel bearings of an automobile, there is placed a magnet that is composed of many magnet faces, 44 magnet pairs by international standard. A GMR device of the invention is placed in the wheel housing, such that the rotating magnet from the wheel bearing places a magnetic field on the GMR device. The magnetic signal is changed to an electrical signal from the magnetoresistive properties of the GMR device. Typically, the GMR device is created in a Wheatstone bridge type configuration, which is well known in the art. This signal is conditioned by electronics to send a digital signal to a controller. The digital signal, along with the time, give the revolutions per minute (rpm) of the wheel. The controller then determines the car conditions, e.g. if a wheel is slipping, and acts accordingly. The GMR structures of the related art are unsuited for use in such vehicular environments, and accordingly are unsatisfactory for this intended purpose.

Varying configurations of the GMR element may be preferred compared to others depending on the application of the magnetoresistive structure. For example, for a hard disk drive, there are microscopic magnets and the size of the GMR device is very important. In an automobile, size is important, but not to the same extent as in a hard drive. Also, in general there is a tradeoff with maximum signal size and sensitivity for varying structures. For example, AMR resistors exhibit a maximum change of resistance of about 3% with a magnetic field of around 20-30 Gauss, while a 3 layer GMR resistor exhibits a resistance change of about 10% at about 100-150 Gauss. Some configurations, such as spin values, may reach 10-15% change of resistance in 10-20 Gauss (bigger signal and more sensitive), but there are trade offs. For example, spin valves may be permanently damaged by a large magnetic field of about 100-150 Gauss.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A structure comprising:
a) a substrate;
b) a first non-magnetically sensitive, electrically conductive, corrosion resistant layer on a surface of the substrate;
c) a multilayer giant magnetoresistance element on a surface of the first non-magnetically sensitive, electrically conductive, corrosion resistant layer, said giant magnetoresistance element comprising:
i) a first magnetically sensitive layer;
ii) a non-magnetically sensitive spacer layer on a surface said first magnetically sensitive layer; and
iii) a second magnetically sensitive layer on a surface of said spacer layer; and
d) a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer.

2. The structure of claim 1 wherein said first non-magnetically sensitive, electrically conductive, corrosion resistant layer and said second non-magnetically sensitive, electrically conductive, corrosion resistant layer each independently comprise a refractory nitride or refractory oxide material.

3. The structure of claim I wherein said first non-magnetically sensitive, electrically conductive, corrosion resistant layer and said second non-magnetically sensitive, electrically conductive, corrosion resistant layer each independently comprise either a tantalum salt or a titanium salt.

4. The structure of claim 1 wherein said first non-magnetically sensitive, electrically conductive, corrosion resistant layer and said second non-magnetically sensitive, electrically conductive, corrosion resistant layer each independently comprise tantalum nitride, tantalum oxide, titanium nitride, titanium oxide, titanium tungsten, or a combination thereof.

5. The structure of claim 1 wherein said first non-magnetically sensitive, electrically conductive, corrosion resistant layer and said second non-magnetically sensitive, electrically conductive, corrosion resistant layer each independently comprise tantalum nitride.

6. The structure of claim 1 wherein said first magnetically sensitive layer and said second magnetically sensitive layer each independently comprise permalloy, nickel, cobalt, iron, manganese, iridium or an alloy or a combination thereof.

7. The structure of claim 1 wherein said first magnetically sensitive layer and said second magnetically sensitive layer each independently comprise a nickel-manganese alloy, a cobalt-iron alloy, a copper-iron alloy, a nickel-iron alloy, a nickel-iron-cobalt alloy, or a combination thereof.

8. The structure of claim 1 wherein said non-magnetically sensitive spacer layer comprises copper, cobalt oxide, rubidium, molybdenum, aluminum oxide, or a combination thereof.

9. The structure of claim 1 wherein said substrate comprises a semiconductor material.

10. The structure of claim 1 wherein said substrate comprises a silicon material.

11. The structure of claim 1 wherein said substrate comprises glass or alumina.

12. The structure of claim 1 wherein said giant magnetoresistance element comprises at least one additional magnetically sensitive layer attached to at least one of said first magnetically sensitive layer and said second magnetically sensitive layer, wherein an additional spacer layer is positioned between adjacent magnetically sensitive layers.

13. An apparatus comprising:
a) a substrate;
b) a first non-magnetically sensitive, electrically conductive, corrosion resistant layer on a surface of the substrate;
c) a multilayer giant magnetoresistance element on a surface of the first non-magnetically sensitive, electrically conductive, corrosion resistant layer, said giant magnetoresistance element comprising:
i) a first magnetically sensitive layer;
ii) a non-magnetically sensitive spacer layer on a surface said first magnetically sensitive layer; and
iii) a second magnetically sensitive layer on a surface of said spacer layer;
d) a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer; and
e) a circuit connected to said second non-magnetically sensitive, electrically conductive, corrosion resistant layer, said circuit being responsive to a change in a magnetic field detected by said giant magnetoresistance element.

14. The apparatus of claim 13 wherein said circuit comprises an integrated circuit.

15. The apparatus of claim 13 wherein said first non-magnetically sensitive, electrically conductive, corrosion resistant layer and said second non-magnetically sensitive, electrically conductive, corrosion resistant layer each independently comprise a refractory nitride or refractory oxide material.

16. The apparatus of claim 13 wherein said first non-magnetically sensitive, electrically conductive, corrosion resistant layer and said second non-magnetically sensitive, electrically conductive, corrosion resistant layer each independently comprise either a tantalum salt or a titanium salt.

17. The apparatus of claim 13 wherein said first non-magnetically sensitive, electrically conductive, corrosion resistant layer and said second non-magnetically sensitive, electrically conductive, corrosion resistant layer each independently comprise tantalum nitride, tantalum oxide, titanium nitride, titanium oxide, titanium tungsten, or a combination thereof.

18. The apparatus of claim 13 wherein said first non-magnetically sensitive, electrically conductive, corrosion resistant layer and said second non-magnetically sensitive, electrically conductive, corrosion resistant layer each independently comprise tantalum nitride.

19. The apparatus of claim 13 wherein said first magnetically sensitive layer and said second magnetically sensitive layer each independently comprise permalloy, nickel, cobalt, iron, manganese, iridium or an alloy or a combination thereof.

20. The apparatus of claim 13 wherein said first magnetically sensitive layer and said second magnetically sensitive layer each independently comprise a nickel-manganese alloy, a cobalt-iron alloy, a copper-iron alloy, a nickel-iron alloy, a nickel-iron-cobalt alloy, or a combination thereof.

21. The apparatus of claim 13 wherein said non-magnetically sensitive spacer layer comprises copper, cobalt oxide, rubidium, molybdenum, aluminum oxide, or a combination thereof.

22. The apparatus of claim 13 wherein said substrate comprises a semiconductor material.

23. The apparatus of claim 13 wherein said substrate comprises a silicon material.

24. The apparatus of claim 13 wherein said substrate comprises glass or alumina.

25. The apparatus of claim 13 wherein said giant magnetoresistance element comprises at least one additional magnetically sensitive layer attached to at least one of said first magnetically sensitive layer and said second magnetically sensitive layer, wherein an additional spacer layer is positioned between adjacent magnetically sensitive layers.

26. The apparatus of claim 13 wherein said circuit comprises a component of a vehicle.

27. A process for forming a structure which comprises:
a) providing a substrate;
b) forming a first non-magnetically sensitive, electrically conductive, corrosion resistant layer on a surface of the substrate;
c) forming a multilayer giant magnetoresistance element on a surface of the first non-magnetically sensitive, electrically conductive, corrosion resistant layer, said giant magnetoresistance element comprising:
i) a first magnetically sensitive layer;
ii) a non-magnetically sensitive spacer layer on a surface said first magnetically sensitive layer; and
iii) a second magnetically sensitive layer on a surface of said spacer layer; and
d) forming a second non-magnetically sensitive, electrically conductive, corrosion resistant layer, wherein said giant magnetoresistance element is positioned between and in contact with each of said first non-magnetically sensitive, electrically conductive, corrosion resistant layer and said second non-magnetically sensitive, electrically conductive, corrosion resistant layer.

28. The process of claim 27 further comprising connecting a circuit to said second non-magnetically sensitive, electrically conductive, corrosion resistant layer, said circuit being responsive to a change in a magnetic field detected by said giant magnetoresistance element.

29. The process of claim 28 wherein said circuit comprises a component of a vehicle.
